(19) United States
(12) Patent Application Publication
(10) Pub. No.: US 2009/0096509 A1
(43) Pub. Date: Apr. 16, 2009

(54) Bandgap Reference Circuits for Providing Accurate Sub-1V Voltages

(76) Inventors: Fang-Shi Jordan Lai, Chia Yi (TW); Chia-Fu Lee, Hsin-Chu (TW); Kuo-Ming Wang, Taipei (TW); Hsu-Feng Hsueh, Tainan (TW)

Correspondence Address: SLATER & MATSIL, L.L.P., 17950 PRESTON ROAD, SUITE 1000, DALLAS, TX, 75252, US

(21) Appl. No.: 11/872,420

(22) Filed: Oct. 15, 2007

(51) Int. Cl. G05F 1/10

(52) U.S. Cl. 327/539

(57) ABSTRACT

A reference voltage circuit includes a first PMOS device having a first source, a first gate, and a first drain, wherein the first source is coupled to a power supply node; and a second PMOS device having a second source, a second gate and, a second drain. The second source is coupled to the power supply node. The first and the second PMOS devices have constant source-drain currents. The reference voltage circuit further includes a third PMOS device having a third source, a third gate, and a third drain; and a resistor coupled between the third drain and the ground. The third source is coupled to the power supply node. The first, the second, and the third gates are interconnected. The first, the second, and the third drains are virtually interconnected.

### TECHNICAL FIELD

This invention relates generally to reference circuits, and more particularly to bandgap reference circuits capable of providing sub-1V reference voltages.

### BACKGROUND

Bandgap reference circuits are widely used in analog circuits for providing stable, voltage-independent, and temperature-independent reference voltages. Bandgap reference circuits are important parts in most precision analog chips.

FIG. 1 illustrates a circuit diagram of a conventional bandgap reference circuit, which includes operational amplifier 100 and PMOS device 106. The drain of PMOS device 106 is coupled to resistors 108 and 114. Resistor 108 is coupled to the ground through diode 112. Resistor 114 is coupled to the ground through resistor 118 and a plurality of diodes 120. Operational amplifier 100 has inputs 102 and 104, which are connected to nodes 110 and 116, respectively.

The reference voltage V122 at node 122 of the circuit shown in FIG. 1 is related to the bandgap reference voltage of diodes 112 and 120. The output reference voltage V122 must be higher than the voltage drop on each of the diodes 112 and 120, and thus is typically about 1.25V or higher. Although output reference voltage V122 is rather stable, output reference voltage V122 is not suitable for sub-1V integrated circuits, which are operated at voltages lower than 1V.

A modified bandgap reference circuit is shown in FIG. 2. An additional PMOS device 130 is added, and the output reference voltage V122 is obtained at the drain of PMOS device 130. Again, inputs 102 and 104 of operational amplifier 100 are connected to nodes 110 and 116, respectively. The output reference voltage V122 at node 122 is determined by the source/drain current I3 of PMOS device 130. Since the output reference voltage V122 is no longer limited by the voltage drops on diodes, the output reference voltage V122 may be lower than 1V. Accordingly, the bandgap reference circuit shown in FIG. 2 may be used in sub-1V applications.

The bandgap reference circuit shown in FIG. 2, however, suffers from relative significant voltage and temperature variations. To ensure that the output reference voltage V122 is constant, current I3 needs to be constant. Current I3 is the counter part of currents I1 and 12, which flow through PMOS devices 106 and 134, respectively. Currents I1 and I2 are further affected by the respective gate voltage and drain voltage of PMOS devices 106 and 134. The drain voltages V110 and V116 of respective PMOS devices 106 and 134 are affected by the voltage drops in diodes 112 and 120. However, the voltages on diodes 112 and 120 are voltage and temperature dependent. Accordingly, PMOS device 130 cannot fully mirror the operation of PMOS devices 106 and 134, and current I3 is prone to the variations in power voltage Vcc and temperatures.

The output reference voltage V122 may have up to ±20 mV variation. This cannot meet the requirements of high precision applications. Bandgap reference circuits that can provide reference voltages with smaller variations are thus needed.

### SUMMARY OF THE INVENTION

In accordance with one aspect of the present invention, a reference voltage circuit includes a first PMOS device having a first source, a first gate, and a first drain, wherein the first source is coupled to a power supply node; a second PMOS device having a second source, a second gate and, a second drain, wherein the second source is coupled to the power supply node, and wherein the first and the second PMOS devices have constant source-drain currents; a third PMOS device having a third source, a third gate, and a third drain, wherein the third source is coupled to the power supply node, and wherein the first, the second, and the third gates are interconnected, and the first, the second, and the third drains are virtually interconnected; and a first resistor coupled between the third drain and a ground.

In accordance with another aspect of the present invention, a reference voltage circuit includes a first PMOS device having a first source, a first gate, and a first drain, wherein the first source is coupled to a power supply node; a second PMOS device having a second source, a second gate, and a second drain, wherein the second source is coupled to the power supply node; a third PMOS device having a third source, a third gate, and a third drain, wherein the third source is coupled to the power supply node; a first operational amplifier having a first input, a second input and an output, wherein the first, the second, and the third gates are connected to the output of the first operational amplifier; a first resistor and a first diode, each coupled between the first drain and the ground; a second resistor coupled between the second drain and the ground; a third resistor connected to the second drain; a second diode coupled between the third resistor and the ground; a second operational amplifier having a first input coupled to the third drain, and a second input coupled to a node selected from the group consisting of the first drain the second drain; and a fourth resistor having a first end coupled to the third drain, and a second end coupled to the ground.

In accordance with yet another aspect of the present invention, a reference voltage includes a first PMOS device having a first source, a first gate, and a first drain, wherein the first source is connected to a power supply node; a second PMOS device having a second source, a second gate, and a second drain, wherein the second source is connected to the power supply node; a third PMOS device having a third source, a third gate, and a third drain, wherein the third source is connected to the power supply node; a first operational amplifier having a first input, a second input, and an output, wherein the first, the second, and the third gates are connected to the output of the first operational amplifier; a first resistor and a first diode, each coupled between the first drain and the ground; a second resistor coupled between the second drain and the ground; a third resistor connected to the second drain; a second diode coupled between the third resistor and the ground; a fourth PMOS device having a fourth source, a fourth gate, and a fourth drain, wherein the fourth source is coupled to the third drain; a second operational amplifier having a first input coupled to the third drain, a second input coupled to a node selected from the group consisting of the first drain and the second drain, and an output coupled to the fourth gate; and a fourth resistor coupled between the fourth drain and the ground.

The embodiments of the present invention have the advantageous features of reduced variations in the reference voltages.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a conventional bandgap reference circuit for providing a reference voltage greater than 1 volt;

FIG. 2 illustrates a conventional bandgap reference circuit for providing a sub-1V reference voltage;

FIG. 3 illustrates an embodiment of the present invention;

FIG. 4 illustrates reference voltages as a function of operation voltages, wherein simulation results of prior art bandgap reference circuits and the embodiments of the present invention are prepared; and

FIG. 5 illustrates reference voltages as a function of temperatures, wherein simulation results of prior art bandgap reference circuits and the embodiments of the present invention are prepared.

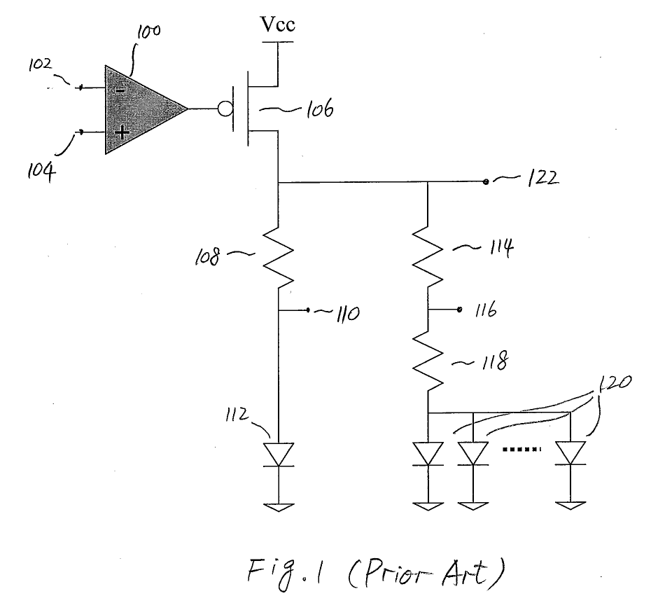

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

FIG. 3 illustrates a circuit diagram of bandgap reference circuit 200, which includes PMOS devices P1, P2, and P3, whose sources are connected to the power supply voltage Vcc. The drain of PMOS device P1 is connected to resistor R1 and diode D1, which are parallel-connected to each other. The drain of PMOS device P2 is connected to resistors R2 and R3, and resistor R3 is further parallel-connected to diodes D2. Diodes D1 and D2 may be connected to ground. Nodes a and b, which are also the drains of PMOS devices P1 and P2, respectively, are connected to inputs of operational amplifier OP1. The output of operational amplifier OP1 is further connected to the gates of the PMOS devices P1, P2, and P3.

Bandgap reference circuit 200 forms a self-biased circuit. The self-bias voltage Vbias is generated at the output of operational amplifier OP1, and is used to bias PMOS devices P1, P2 and P3, preferably in their respective saturation regions. The total saturation current of diodes D2 is preferably greater that the saturation current of diode D1, and the ratio of the total saturation current of diodes D2 relative to the saturation current of diode D1 is represented as N. Diodes D2 may include a plurality of diodes, each identical to diode D1. Diodes D2 may also be replaced by a single diode having a saturation current equal to the total saturation current of diodes D2.

In the following paragraphs, the mechanism of bandgap reference circuit 200 is briefly discussed. For the simplicity of discussion, it is assumed that PMOS devices P1, P2, and P3 are identical, although they can be different. It is further assumed that resistors R1 and R2 are identical. Again, they can also be different in practical cases.

Due to the properties of operational amplifiers, the inputs a and b of operational amplifier OP1 are virtually interconnected. Throughout the description, the term “virtually interconnected” refers to nodes physically disconnected, but always having a same voltage. The voltage Va at node a and voltage Vb at node b are equal to each other:

Va=Vb [Eq. 1]

Since PMOS devices P1 and P2 are identical, and the source voltage, drain voltage, and gate voltage of PMOS device P1 are the same as the respective source voltage, drain voltage, and gate voltage of PMOS device P2, the source-drain current I1 of PMOS device P1 and source-drain current I2 of PMOS device P2 are the same:

I1=I2 [Eq. 2]

Since R1 is equal to R2, current I1a is equal to current I2a, and current I1b is equal to current I2b. The voltage difference dVf applied on resistor R3 may thus be expressed as:

dVf=Vf1−Vf2=V_{T}*ln(N) [Eq. 3]

wherein voltage Vf1 is the voltage drop on diode D1, voltage Vf2 is the voltage drop on diodes D2, V_{T} is the thermal voltage (or kT/q, wherein q is the electron charge, k is the Boltzmann's constant, and T is absolute temperature), and N is the ratio of the total saturation current of diodes D2 to the saturation current of diode D1.

Further, current I2a may be expressed as:

I2a=dVf/R3 [Eq. 4]

I2b may be expressed as:

I2b=Vf1/R2 [Eq. 5]

I2 is the sum of currents I2a and I2b, and hence the following equation holds:

I2=I2a+I2b=dVf/R3+Vf1/R2 [Eq. 6]

It is appreciated that the voltage drop Vf1 on diode D1 has a negative temperature coefficient, and thus current I2a has a negative temperature coefficient. Conversely, Equation 3 indicates that voltage different dVf is proportional to thermal voltage, or kT/q, and thus current I2b has a positive temperature coefficient. By selecting appropriate values of resistors R1, R2, R3, and resistors D1 and D2 (including ratio N), the effects of the positive temperature coefficient of I2b and the negative temperature coefficient of current I2a may substantially cancel each other. The resulting temperature dependence of current I2 is thus very small, and is negligible. Furthermore, it may also be concluded from the above-equations that I2 is independent from power supply voltage Vcc.

The bandgap reference circuit 200 further includes operational amplifier OP2, which has a first input c connected to the drain of PMOS device P3, and a second input d connected to either node a or node b. By this setting, nodes a, b, c are all virtually interconnected, and thus have the same voltages. Assuming node d is connected to node b, then the drain voltage, source voltage, and gate voltage of PMOS device P3 are identical to the drain voltage, source voltage, and gate voltage of PMOS device P2, respectively. PMOS device P3 may thus fully mirror the operation of MOS device P2, and current I3 is accordingly identical to current I2, which is further identical to current I1. Similarly, if node d is connected to node a, currents I1, I2 and I3 will also be equal to each other.

As discussed in the preceding paragraphs, current I2 is constant, and is substantially free from variations in power supply voltage Vcc and the temperature, current I3 is thus constant and is free from variations in power supply voltage Vcc and the temperature. The output reference voltage Vref is equal to I3*R4, accordingly, output reference voltage Vref is a constant and is free from variations in power supply voltage Vcc and the temperature.

In the preferred embodiment, by adjusting R4, the desirable output reference voltage Vref may be obtained. Alternatively, the desirable output reference voltage Vref may be obtained by adjusting currents I1 and I2 (and hence current I3), which may be achieved by selecting appropriate diodes D1, D2, and resistors R1, R2, and R3.

In the embodiments discussed in the preceding paragraphs, it is assumed that PMOS devices P1, P2, and P3 are identical, so that when biased under the same voltages, the source-to-drain currents flowing through them are the same. In alternative embodiment, PMOS devices P1, P2, and P3 may be different. For example, if PMOS device P3 is fabricated to have a different gate-width to gate-length ratio (W/L) than PMOS devices P1, P2, then current I3 will be exactly proportional to, although not equal to, currents I1 and I2. Throughout the description, current I3 is referred to as “mirroring” currents I1 and I2 if I3 is proportional to or equal to currents I1 and I2. In the case current I3 is proportional to, but not equal to, currents I1 and I2, the resulting output reference voltage Vref will still be a constant and is free from variations in power voltage Vcc and the temperature. In yet other embodiments, PMOS devices P1 and P2 are different, for example, having different W/L ratios. Accordingly, resistors R1, R2, and R3, and diodes D1 and D2 need to be adjusted to achieve constant currents I1 and I2.

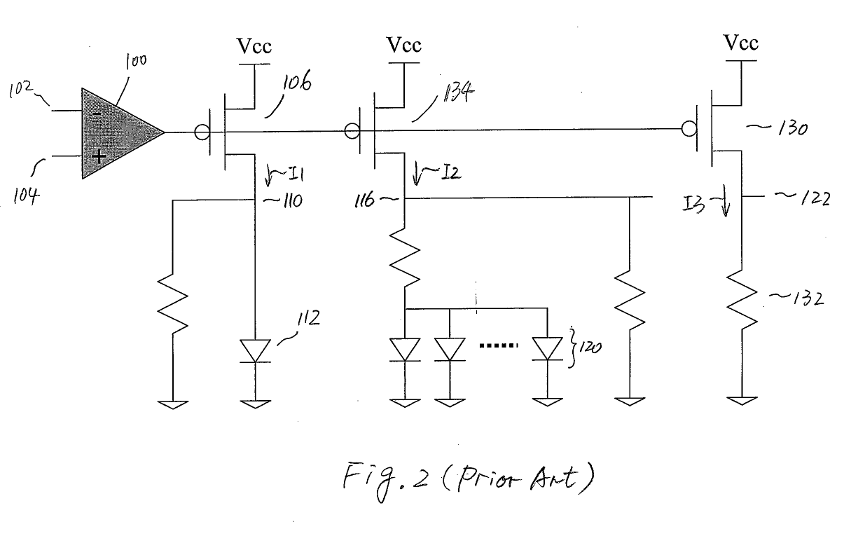

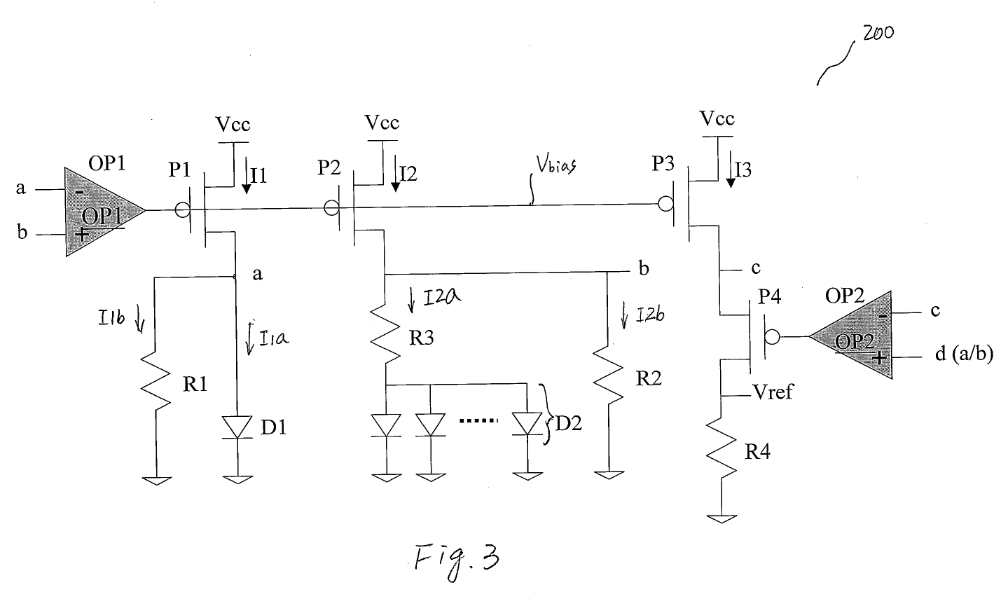

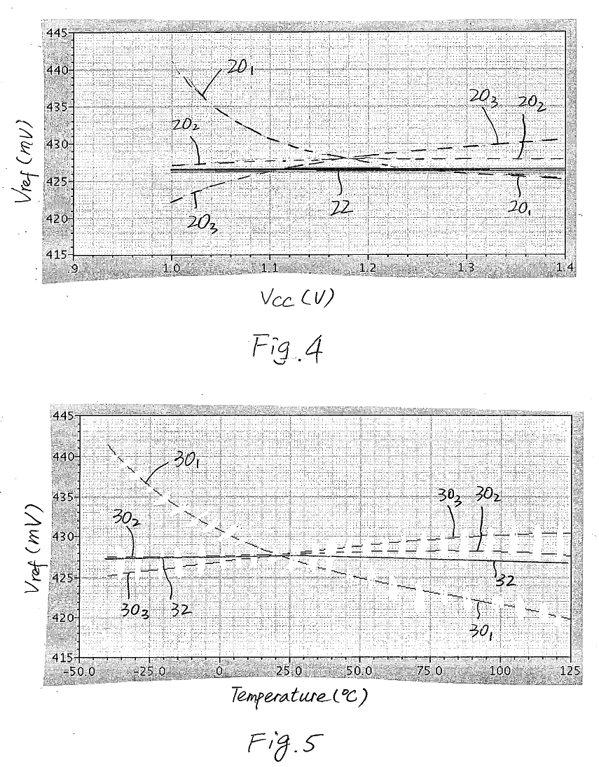

The embodiments of the present invention have several advantageous features. Firstly, the output reference voltage Vref may be lower than 1 volt, and thus the bandgap reference circuits of the present invention can be used for sub-1V applications. Secondly, the output reference voltage Vref is free from the variations in power voltage Vcc even if voltage Vcc varies in a wide range. FIG. 4 compares the performance of a prior art circuit shown in FIG. 2 and a circuit shown in FIG. 3, wherein the output reference voltages are shown as functions of power voltage Vcc. Line 20₁ is the simulation result for a temperature of −40° C., line 20₂ is the simulation result for a temperature of 25° C., while line 20₃ is the simulation result for a temperature of 125° C. The circuit shown in FIG. 2 is tuned for the room temperature (25° C.). Therefore, line 20₂ has a low voltage dependence, and when the operation voltage changes from 1 volt to 1.4 volts, the variations in the output reference voltage Vref is relatively low. However, when the circuit shown in FIG. 2 is operated a lower temperature (line 20₁) or a higher temperature (line 20₃), there are significant variations (up to about ±20 mV) in the output reference voltages Vref when the power voltage Vcc varies from 1 volt to 1.4 volts. As a comparison, line 22 shows a simulation result of the circuit shown in FIG. 3, wherein the results for −40° C., 25° C., and 125° C. overlap each other. It is noted that when power voltage Vcc varies from 1V to 1.4V, the variations in the output reference voltages Vref are all less than about ±0.5 mV.

Thirdly, the output reference voltage Vref is free from the variations in temperature even if the temperature varies in a wide range. FIG. 5 compares the performance of prior art circuit shown in FIG. 2 and the circuit shown in FIG. 3, wherein the output reference voltages are shown as functions of temperatures. Line 30₁ is the simulation result for the operation voltage of 1 volt, line 30₂ is the simulation result for the operation voltage of 1.2 volts, while line 30₃ is the simulation result for the operation voltage of 1.4 volts. The circuit shown in FIG. 2 is tuned for the operation voltage of 1.2 volts. Therefore, line 30₂ has a low temperature dependence, and the variations in the output reference voltage Vref is relatively low. However, when the circuit shown in FIG. 2 is operated at a lower power supply voltage (line 30₁) or a higher power supply voltage (line 30₃), there are significant variations (up to about ±20 mV) in the output reference voltages Vref when the temperature varies from −40° C. to 125° C. As a comparison, line 32 shows a simulation result of the circuit shown in FIG. 3, wherein the results for operation voltages of 1 volt, 1.2 volts and 1.4 volts overlap each other. It is noted that when the temperature varies from −40° C. to 125° C., the variations in the output reference voltages Vref are all less than about ±0.5 mV.

Although not discussed in preceding paragraphs, the embodiments of the present invention may require a start-up mechanism because if the input voltages of operational amplifiers OP1 and OP2 happen to be equal to zero, the operational amplifiers OP1 and OP2 may be turned off. The start-up mechanism, and corresponding circuits, can be added to ensure the operational amplifiers OP1 and OP2 to be turned on whenever a supply voltage is provided.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A circuit comprising:
a first PMOS device having a first source, a first gate, and a first drain, wherein the first source is coupled to a power supply node;
a second PMOS device having a second source, a second gate, and a second drain, wherein the second source is coupled to the power supply node, and wherein the first and the second PMOS devices have constant source-drain currents;
a third PMOS device having a third source, a third gate, and a third drain, wherein the third source is coupled to the power supply node, and wherein the first, the second, and the third gates are interconnected, and the first, the second and the third drains are virtually interconnected; and
a first resistor coupled between the third drain and a ground.

2. The circuit of claim 1, wherein the first drain is coupled to the ground through a first diode and a first resistor, and wherein the first diode and the first resistor are parallel connected.

3. The circuit of claim 1, wherein the second drain is coupled to the ground through a second diode, a second resistor, and a third resistor, wherein the second diode and the second resistor are serially connected to form a sub circuit, and wherein the sub circuit and the third resistor are connected in parallel.

4. The circuit of claim 3 further comprising additional diodes connected in parallel with the second diode.

5. The circuit of claim 1, wherein the first and the second drains are each connected to an input of a first operational amplifier, the first, the second, and the third gates are connected to an output of the first operational amplifier, and wherein a node selected from the group consisting essentially of the first and the second drains is connected to a first input of a second operational amplifier, and wherein the third drain is connected to a second input of the second operational amplifier.

6. The circuit of claim 5 further comprising a fourth PMOS device having a fourth source, a fourth drain, and a fourth gate, wherein the fourth source is connected to the third drain and the second input of the second operational amplifier, and the fourth gate is connected to an output of the second operational amplifier.

7. The circuit of claim 1, wherein the first and the second PMOS devices are identical, and wherein the third PMOS device has a W/L ratio different from a W/L ratio of the first and the second PMOS devices.

8. The circuit of claim 1, wherein the first, the second, and the third PMOS devices are identical.

9. A circuit comprising:
a first PMOS device having a first source, a first gate, and a first drain, wherein the first source is coupled to a power supply node;
a second PMOS device having a second source, a second gate, and a second drain, wherein the second source is coupled to the power supply node;
a third PMOS device having a third source, a third gate, and a third drain, wherein the third source is coupled to the power supply node;
a first operational amplifier having a first input, a second input, and an output, wherein the first, the second, and the third gates are connected to the output of the first operational amplifier;
a first resistor and a first diode, each coupled between the first drain and the ground;
a second resistor coupled between the second drain and the ground;
a third resistor connected to the second drain;
a second diode coupled between the third resistor and the ground;
a second operational amplifier having a first input coupled to the third drain, and a second input coupled to a node selected from the group consisting of the first drain and the second drain; and
a fourth resistor having a first end coupled to the third drain, and a second end coupled to the ground.

10. The circuit of claim 9 further comprising a fourth PMOS device having a fourth source connected to the third drain, a fourth gate connected to the output of the second operational amplifier, and a fourth drain coupled to the first end of the fourth resistor.

11. The circuit of claim 9, wherein the first and the second PMOS devices are substantially identical.

12. The circuit of claim 9, wherein the first, the second, and the third PMOS devices are substantially identical.

13. The circuit of claim 9, wherein the second diode has a saturation current greater than the first diode.

14. The circuit of claim 9 further comprising an additional diode parallel-connected to the second diode, wherein the first diode, the second diode and the additional diode are substantially identical.

15. A circuit comprising:
a first PMOS device having a first source, a first gate, and a first drain, wherein the first source is connected to a power supply node;
a second PMOS device having a second source, a second gate, and a second drain, wherein the second source is connected to the power supply node;
a third PMOS device having a third source, a third gate, and a third drain, wherein the third source is connected to the power supply node;
a first operational amplifier having a first input, a second input, and an output, wherein the first, the second, and the third gates are connected to the output of the first operational amplifier;
a first resistor and a first diode, each coupled between the first drain and the ground;
a second resistor coupled between the second drain and the ground;
a third resistor connected to the second drain;
a second diode coupled between the third resistor and the ground;
a fourth PMOS device having a fourth source, a fourth gate, and a fourth drain, wherein the fourth source is coupled to the third drain;
a second operational amplifier having a first input coupled to the third drain, a second input coupled to a node selected from the group consisting of the first drain and the second drain, and an output coupled to the fourth gate; and
a fourth resistor coupled between the fourth drain and the ground.

16. The circuit of claim 15, wherein the first and the second PMOS devices are substantially identical.

17. The circuit of claim 15, wherein the first, the second and the third PMOS devices are substantially identical.

18. The circuit of claim 15, wherein the second diode has a greater saturation current than the first diode.

19. The circuit of claim 15 further comprising a third diode connected to the second diode in parallel, wherein the first, the second, and the third diodes are substantially identical.

20. The circuit of claim 15 further comprising an output node connected to the fourth drain.
